(19) United States
(12) Patent Application Publication
(10) Pub. No.: US 2009/0170001 A1
(43) Pub. Date: Jul. 2, 2009

(54) ELECTROCHEMICAL ENERGY SOURCE, ELECTRONIC MODULE, ELECTRONIC DEVICE, AND METHOD FOR MANUFACTURING OF SAID ENERGY SOURCE

(75) Inventors: Freddy Roozeboom, Eindhoven (NL); Peter Motten, Eindhoven (NL); Antonius Lucien Adrianus Maria Kemmeren, Eindhoven (NL); Johan Hendrik Klootwijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,866

(22) PCT Filed: Nov. 25, 2005
(86) PCT No.: PCT/IB05/53913

§ 371 Date: May 22, 2007

(30) Foreign Application Priority Data
Nov. 26, 2004 (EP) 04106120.1

(51) Int. Cl. H01M 4/56; H01M 4/02; H01M 4/58

(52) U.S. Cl. 429/225; 429/209; 429/218.1; 429/231.8

(57) ABSTRACT

The invention relates to an electrochemical energy source comprising at least one assembly of: a first electrode, a second electrode, and an intermediate solid-state electrolyte separating said first electrode and said second electrode. The invention also relates to an electronic module provided with such an electrochemical energy source. The invention further relates to an electronic device provided with such an electrochemical energy source. Moreover, the invention relates to a method of manufacturing of such an electrochemical energy source.

The invention relates to an electrochemical energy source comprising at least one assembly of: a first electrode, a second electrode, and an intermediate solid-state electrolyte separating said first electrode and said second electrode. The invention also relates to an electronic module provided with such an electrochemical energy source. The invention further relates to an electronic device provided with such an electrochemical energy source. Moreover, the invention relates to a method of manufacturing of such an electrochemical energy source.

Electrochemical energy sources based on solid-state electrolytes are known in the art. These (planar) energy sources, or ‘solid-state batteries’, are constructed as stated in the preamble. Solid-state batteries efficiently and cleanly convert chemical energy directly into electrical energy and are often used as the power sources for portable electronics. At a smaller scale such batteries can be used to supply electrical energy to e.g. microelectronic modules, more particular to integrated circuits (IC's). An example hereof is disclosed in the international patent application WO 00/25378, where a solid-state thin-film micro battery is fabricated directly onto a specific substrate. During this fabrication process the first electrode, the intermediate solid-state electrolyte, and the second electrode are subsequently deposited onto the substrate. Although the known micro battery exhibits commonly superior performance as compared to other solid-state batteries, the known micro battery has several drawbacks. A major drawback of the known micro battery of WO 00/25378 is that its manufacturing process is relatively complex and therefore relatively expensive.

It is an object of the invention to provide an improved electrochemical energy source, which can be constructed and manufactured in a relatively simple manner, while being able to maintain the advantage of the known electrochemical energy sources.

The object of the invention is achieved by an electrochemical energy source according to the preamble, characterized in that said first electrode comprises a conductive substrate and a conductive top layer applied on said substrate, wherein said top layer is at least partially provided with multiple surface increasing grains, on which top layer the solid-state electrolyte and the second electrode being deposited. In this way the electron-conducting substrate also functions as at least a part of the first electrode. The integration of said substrate and at least a part of said first electrode leads commonly to a simpler construction of the (micro)battery compared to those known in the art. Moreover, the way of manufacturing of an energy source according to the invention is also simpler, as at least one process step can be eliminated. The relatively simple manufacturing method of the solid-state energy source according to the invention may furthermore lead to a significant cost saving. Preferably, the solid-state electrolyte and the second electrode are deposited on the first electrode as thin film layers with a thickness of approximately between 0.5 and 5 micrometer. Thin film layers result in higher current densities and efficiencies because the transport of ions in the energy source is easier and faster through thin-film layers than through thick-film layers. In this way the internal energy loss may be minimized. As the internal resistance of the energy source is relatively low the charging speed may be increased when a rechargeable energy source is applied. A further major advantage of the energy source according to the invention is that application of multiple (nano)grains results in a certain “texturing” or roughening of the first electrode, in particular of a part of the top layer facing the electrolyte, to increase its effective surface area. In this manner, the effective surface area can be increased approximately 2 to 2.5 times with respect to a conventional relatively smooth contact surface of the first electrode, resulting in a proportional increase of the energy density and power density of the electrochemical energy source. The top layer can be deposited as a separate layer onto the substrate, for example by way of low pressure chemical vapor deposition (LPVCD), wherein both the substrate and the top layer form de facto the first electrode. In another embodiment, the top layer can be formed by means of implantation techniques, wherein an outer part of the substrate of bombarded with ions, to change, in particular to damage, the crystalline structure of this outer part and to form the top layer, as a result of which the first electrode can also be built up out of multiple identifiable layers with different structures.

In a preferred embodiment at least a part of the first electrode facing the electrolyte and the second electrode is patterned at least partially. In this way a further increased contact surface per volume between both electrodes and the solid-state electrolyte is obtained. Commonly, this increase of the contact surface(s) between the components of the energy source according to the invention leads to an improved rate capacity of the energy source, and hence a better battery capacity (due to an optimal utilization of the volume of the layers of the energy source). In this way the power density in the energy source may be maximized and thus optimized. The nature, shape, and dimensioning of the pattern may be arbitrary.

In general, the contact surface may be patterned in various ways, e.g. by providing extensions to the first electrode. Preferably, the first electrode, in particular the substrate, is provided with a plurality of cavities of an arbitrary shape and dimensioning. The top layer is deposited onto said substrate and commonly covers said substrate within said cavities, wherein the electrolyte and the second electrode being provided to at least a part of an inner surface of said cavities. This has the advantage that the patterned contact surface may be manufactured in a relatively simple way. In a preferred embodiment at least a part of the cavities form slits, holes or trenches in which the solid-state electrolyte and the second electrode are deposited. The pattern, more particular the cavities, of the first electrode, in particular of the conductive substrate, may be formed for example by way of etching. In a particular preferred embodiment the inner surface of the cavities of the first electrode is at least substantially covered by the surface increasing grains. In this manner, a doubling of effective surface area of the first electrode can be obtained, resulting in an increased energy density and power density of about 20 to 25 times the energy density respectively power density of a conventional electrochemical energy source with a flat (internal) geometry.

In another preferred embodiment the cavities are linked, through which one or multiple protruding elements, in particular pillars, are formed on the substrate to increase the effective contact surface within the electrochemical energy source. Instead of using trenches or pores, which involve processing for forming and filling a hole in the form of a trench or a pore in the substrate, thus also an inverted structure can be used. The pillars of the first electrode are preferably formed by an etching process that forms vertical pillars in the substrate of the first electrode instead of vertical holes. The shape and dimensioning of the pillars may be of various nature and are preferably dependent on the field of application of the electrochemical energy source according to the invention. This also allows an easier three-dimensional diffusion of gaseous reagents and reaction products, thus enabling higher reaction rates in the processes involved, e.g., dry-etching etching of the features and deposition of LPCVD or ALD-grown layers onto the features.

The size of the grains of the top layer can vary. These grains are typically known as hemispherical grain silicon, also referred to as HSG. Commonly, the top layer is subjected to a surface modification treatment to generate the surface increasing grains. During this treatment the majority of grains, in particular the boundaries of these grains, will commonly fuse slightly to form a porous texture with a relatively high effective surface area. However, in this texture the grains can commonly be individualized, wherein the diameter of the surface increasing grains is preferably substantially lain between 10 and 200 nanometer, preferably between 10 and 60 nanometer. It may be clear that the diameter may exceed this range in case of coalescence of multiple grains. The mutual distance (pitch) between two neighboring grains is preferably lain between certain nanometers to about 20 nanometer.

In a preferred embodiment the substrate is made of at least one of the following materials: C, Si, Sn, Ti, Al, Ge and Pb. A combination of these materials may also be used to form the (porous) substrate. Preferably, n-type or p-type doped Si is used as substrate, or a doped Si-related compound, like SiGe or SiGeC. Also other suitable materials may be applied as substrate, provided that the material of the substrate is adapted for intercalation and storing of ions such as e.g. of those atoms as mentioned in the previous paragraph. Moreover, these materials are preferably suitable to undergo an etching process to apply a pattern (holes, trenches, pillars, etc.) on the contact surface of the substrate.

In an embodiment the first electrode is at least partially adapted for (temporary) storage of ions of at least one of following atoms: H, Li, Be, Mg, Na and K. So, the electrochemical energy source according to the invention may be based on various intercalation mechanisms and is therefore suitable to form different kinds of batteries, e.g. Li-ion batteries, NiMH batteries, et cetera. Preferably, the substrate and the top layer are separated by means of an electron-conductive barrier layer adapted to at least substantially preclude diffusion of intercalating ions into said substrate. This preferred embodiment is commonly very advantageous, since intercalating ions taking part of the (re)charge cycles of the electrochemical source according to the invention often diffuse into the substrate, such that these ions do no longer participate in the (re)charge cycles, resulting in a diminished storage capacity of the electrochemical source. Commonly, a monocrystalline conductive silicon substrate is applied to carry electronic components, such as integrated circuit, chips, displays, et cetera. This crystalline silicon substrate suffers from this drawback that the intercalating ions diffuse relatively easily into said substrate, resulting in a reduced capacity of said energy source. For this reason it is considerably advantageous to apply a barrier layer onto said substrate to preclude said unfavorable diffusion into the substrate. Migration of the intercalating ions will be blocked at least substantially by said barrier layer, as a result of which migration of these ions through the substrate will no longer occur, while migration of electrons through said substrate is still possible. According to this embodiment it is no longer necessary that the substrate is adapted for storage of the intercalating ions. To this end, merely the top layer will act as an intercalating layer adapted for temporary storage (and release) of ions of for example lithium. Therefore, it is also possible to apply electron-conductive substrates other than silicon substrates, like substrates made of metals, conductive polymers, et cetera. The so formed laminate of said substrate, said barrier layer, and said top layer as intercalating layer will commonly be formed—as mentioned afore—by stacking (depositing) the barrier layer and subsequently the intercalating layer onto said substrate, for example by way of low pressure Chemical Vapor Deposition (LPCVD). However, in a particular embodiment the laminate can also be formed by means of implantation techniques, wherein for example a crystalline silicon substrate is bombarded with for example tantalum ions and nitrogen ions, after which the temperature of the implanted substrate is sufficiently raised to form the physical barrier layer buried within said original substrate. As a result of the bombardment of the silicon substrate with ions, commonly the lattice of the crystalline top layer of the original substrate will be destructed, resulting in an amorphous top layer forming said intercalating layer. In a preferred embodiment said intercalating top layer is at least substantially made of silicon, preferably doped amorphous silicon. An amorphous silicon layer has an outstanding property to store (and release) relatively large amounts of intercalating ions per unit of volume, which results in an improved storage capacity of the electrochemical source according to the invention. Said barrier layer is preferably at least substantially made of at least one of the following compounds: tantalum, tantalum nitride, and titanium nitride. The material of the barrier layer is, however, not limited to these compounds. These compounds have as common property a relatively dense structure which is impermeable for the intercalating ions, among which lithium ions.

The solid-state electrolyte applied in the energy source according to the invention may be based either on ionic conducting mechanisms or non-electronic conducting mechanisms, e.g. ionic conductors for H, Li, Be and Mg. An example of a Li conductor as solid-state electrolyte is Lithium Phosphorus Oxynitride (LiPON). Other known solid-state electrolytes like e.g. Lithium Silicon Oxynitride (LiSiON), Lithium Niobate (LiNbO₃), Lithium Tantalate (LiTaO3), Lithium orthotungstate (Li₂WO4), and Lithium Germanium Oxynitride (LiGeON) may also be used as lithium conducting solid-state electrolyte. A proton conducting electrolyte may for example be formed by TiO(OH). Detailed information on proton conducting electrolytes is disclosed in the international application WO 02/42831. The second (positive) electrode for a lithium ion based energy source may be manufactured of metal-oxide based materials, e.g. LiCoO₂, LiNiO₂, LiMnO₂ or a combination of these such as. e.g. Li(NiCoMn)O₂. Examples of a second (positive) electrode in case of a proton based energy source are Ni(OH)₂ and NiM(OH)₂, wherein M is formed by one or more elements selected from the group of e.g. Cd, Co, or Bi.

In yet another embodiment the solid-state electrolyte and the second electrode are deposited on the top layer which is applied to multiple sides of the substrate. In this way the substrate is used more effectively and more intensively for storage of ions, thereby increasing the electric capacity of the electrochemical energy source according to the invention.

Preferably, the electrochemical energy source comprises multiple assemblies electrically coupled together. The assemblies may be coupled both in a serial and/or in a parallel way dependent on the requirements of the application of the electrochemical energy source. When a relatively high current is required, the first electrodes and the second electrodes of several assemblies are electrically coupled in parallel, respectively. When a relatively high voltage is required, the first electrode of a first assembly may be electrically coupled to the second electrode of a second assembly. The first electrode of the second assembly may be electrically coupled to a second electrode of a third assembly and so forth.

At least one of the first electrode and the second electrode is preferably coupled to a current collector. In case of a silicon substrate a current collector may not be needed for the first electrode. However, for e.g. a Li-ion battery with a LiCoO₂ electrode as second electrode preferably an aluminum current collector (layer) is applied. Alternatively or in addition a current collector manufactured of, preferably doped, semiconductor such as e.g. Si, GaAs, InP, as of a metal such as copper or nickel may be applied as current collector in general with solid-state energy sources according to the invention.

The substrate may have a main surface on or in which the cavities are formed and which defines a plane. A perpendicular projection of the current collector onto this plane may at least party overlap with a perpendicular projection of a cavity, and preferably with all cavities, onto this plane. In this way the current collector is relatively near by the cavity, which increases the maximum current. In an embodiment the current collector extends into a cavity, preferably into all cavities. This increases the rate capacity further. It is particularly advantageous for relatively deep cavities having a depth of 20 micrometer or more.

The substrate may comprise a first part, which constitutes the first electrode, and a second part free from the first part. The second part may comprise an electric device integrated in the second part. Preferably, the substrate comprises a barrier layer for reducing and preferably substantially preventing diffusion of ions from the first part to the second part. When the substrate is adapted for storage of Li-ions, for example by applying a silicon wafer, such a barrier layer can be formed of Si₃N₄ or SiO₂ to prevent the Li-ions to exit the first electrode (wafer).

Preferably, the substrate is supported by a support structure in order to consolidate the electrochemical energy source. In specific cases application of such a support structure may be desirable. For example if a titanium (-related) substrate is used for hydrogen storage in a nigh battery with a structure according to the invention, a support structure may be used to strengthen the construction of the energy source. Noted is that a titanium substrate may be manufactured by way of a (temporarily) dielectric layer on which the substrate is deposited. After this depositing process the dielectric layer may be removed. For further support of the titanium substrate the electrically non-conducting support structure may be used. It may be advantageous to remove the substrate partially by decreasing its thickness, and therefore improving the energy density of the energy source. For example from a substrate with a thickness of about 500 micrometer the energy source may be transferred to a substrate with a thickness of about 10-200 micrometer. To establish this adaptation of the substrate the (known) ‘substrate transfer technology’ may be applied.

The invention further relates to an electronic module provided with at least one of such an electrochemical energy source. The electronic module may be formed by an integrated circuit (IC), microchip, display, et cetera. The combination of the electronic module and the electrochemical energy source may be constructed in a monolithic or in non-monolithic way. In case of a monolithic construction of said combination preferably a barrier layer for ions is applied between the electronic module and the energy source. In an embodiment the electronic module and the electrochemical energy source form a System in Package (SiP). The package is preferably non-conducting and forms a container for the aforementioned combination. In this way an autonomous ready-to-use SiP may be provided in which besides the electronic module an energy source according to the invention is provided.

The invention further relates to an electronic device provided with at least one of such an electrochemical energy source, or more preferably such an electronic module. An example of such an electric device is a shaver, wherein the electrochemical energy source may function for example as backup (or primary) power source. Other applications which can be enhanced by providing a backup power supply comprising an electrochemical energy source according to the invention are for example portable RF modules (like e.g. cell phones, radio modules, et cetera), sensors and actuators in (autonomous) Microsystems, energy and light management systems, but also digital signal processors and autonomous devices for ambient intelligence. It may be clear this enumeration may certainly not being considered as being limitative.

Another example of an electric device wherein an energy source according to the invention may be incorporated is a so-called ‘smart card’ containing a microprocessor chip. Current smart cards require a separate bulky card reader to display the information stored on the card's chip. But with a, preferably flexible micro battery, the smart-card may comprise for example a relatively tiny display screen on the card itself that allows users easy access to data, stored on the smart card.

The invention relates moreover to a method for manufacturing of such an electrochemical energy source, comprising the steps of: A) applying a conductive top layer on a conductive substrate, wherein said top layer is provided with multiple surface increasing grains, B) depositing the solid-state electrolyte on at least a part of the top layer, and C) subsequently depositing of the second electrode on at least a part of the electrolyte. During the application of step B) and step C) preferably one of the following deposition techniques is used: Physical Vapor Deposition (PVD), Chemical Vapor Deposition (CVD), and Atomic Vapor Deposition (AVD). Examples of PVD are sputtering and laser ablation that requires commonly trench widths of the order of ≧20 micrometer. Examples of CVD are LP-CVD and Atomic Layer Deposition (ALD). The AVD is preferably carried out at relatively low pressures (approximately 150 mbar or lower). These techniques are well known for the artisan and allow a pore diameter in the substrate of the order of >0.5 micrometer and a very step-conformal layer with uniform thickness. Subsequent to step C) the second electrode is preferably leveled by means of a separate conductive leveling layer. Preferably, depositing of the top layer onto the substrate according to step A) is realized by the steps D) applying a top layer of, preferably doped, amorphous silicon onto said substrate, E) patterning said top layer, preferably by making use of dry and/or anisotropic etching techniques, such as sputter etching, and F) allowing surface increasing grains, in particular hemispherical silicon grains (HSG), to grow selectively onto the patterned top layer. The etching treatment according to step E) is preferably carried out without a mask. In this manner, the HSG formation according to step F) proceeds commonly in a self aligned way. The roughening of the effective surface area due to HSG formation is believed to be caused by the high mobility of Si atoms on the clean Si surface, leading to a more or less hemispherical grain surface structure. Previously, during conventional low pressure chemical vapor deposition (LPCVD) of (cracked) SiH₄, processes at 1.33 mbar and 0.3 mbar were reported to yield effective area enhancements of 2.1 to 2.5 times. In these experiments substantial silicon surface roughness and capacitance enhancement were obtained only in a narrow (<10° C.) window of deposition temperatures centered at 550° C. Since this is the boundary between amorphous and polycrystalline silicon growth, the roughness mechanism appears associated with a delicate balance of kinetics between surface deposition/growth and surface diffusion. Later, direct CVD growth was reported of rough Si films over a much broader temperature range (>100° C.) carried out by SiH₄ growth (undiluted) on SiO₂ surfaces at relatively low temperatures (600° C.) and at low pressures (<1 mbar). Under these conditions the broad temperature window for rough Si film morphology is achieved through the combination of nucleation-controlled initial growth (on SiO₂) and domination of growth by surface reaction (cf. gas phase). Preferably, applying a top layer of, preferably doped, amorphous silicon onto said substrate according to step D) is executed at a temperature of between 515 and 525 degrees Celsius. However, seeding of nuclei of silicon particles on said layer, and allowing the top layer to anneal according to step F) to form the desired surface increasing (hemispherical) silicon grains, is preferably executed at a temperature of between 545 and 610 degrees Celsius. At higher temperatures commonly polycrystalline micro-fragments will be generated, resulting in an undesired relatively low effective surface area.

In a preferred embodiment the method is provided with step G) comprising patterning at least one contact surface of the substrate, wherein step G) is applied preceding prior to step A). As explained afore the patterning of a surface of the substrate by applying cavities, like for example trenches, holes, pillars, sleeves, or other kinds of pores, further increases the contact surface per volume unit of the different components of the energy source, thereby further increasing the rate capability. In an embodiment an etching technique may be used for patterning such as wet chemical etching and dry etching. Well-known examples of these techniques are RIE and Focused Ion Beam (FIB). Preferably, the amorphous doped silicon on an upper (substantially flat) surface is etched during step B), while the amorphous silicon within the cavities is not etched. Subsequently, grains are formed on the amorphous silicon top layer, which is substantially merely present at the inner side walls of the cavities.

In a preferred embodiment, the method is provided with step H) comprising depositing of a electron-conductive barrier layer onto the substrate, wherein step H) is applied prior to step A), and wherein during step A) the top layer is deposited onto said barrier layer. Advantages of this particular embodiment have been elucidated above in a comprehensive manner.

The invention is illustrated by way of the following non-limitative examples, wherein:

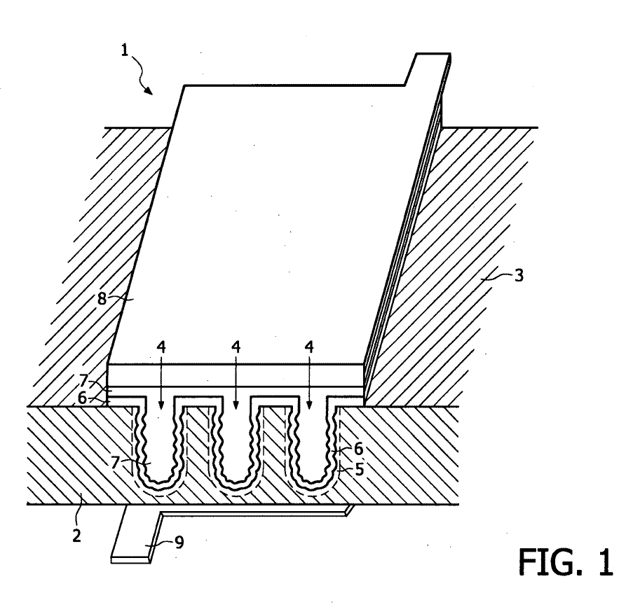

FIG. 1 shows a perspective view of an electrochemical energy source according to the invention,

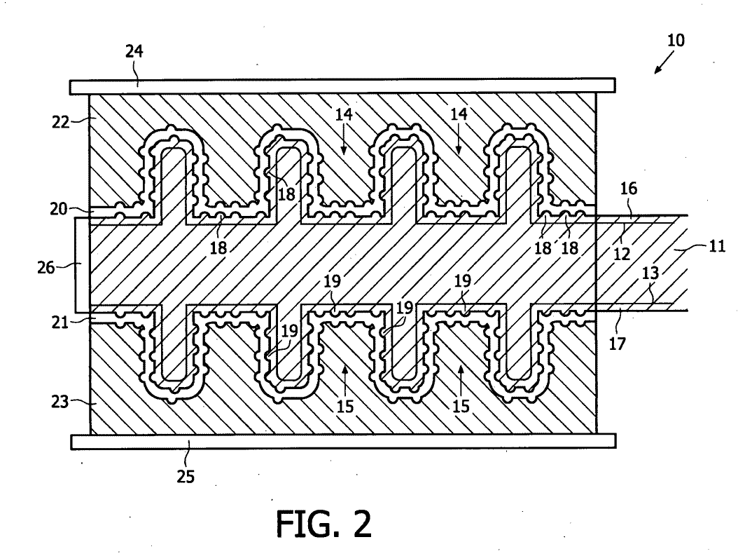

FIG. 2 shows a cross section of another electrochemical energy source according to the invention,

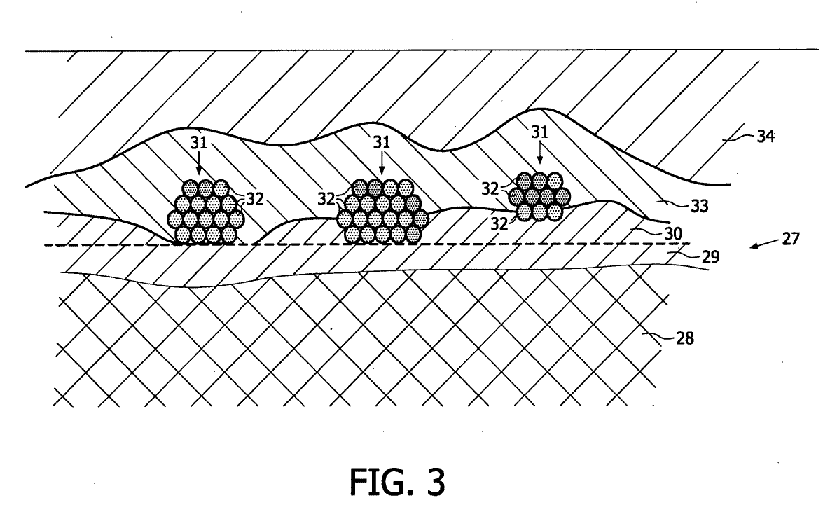

FIG. 3 shows an exaggerated detailed view of yet another electrochemical energy source according to the invention,

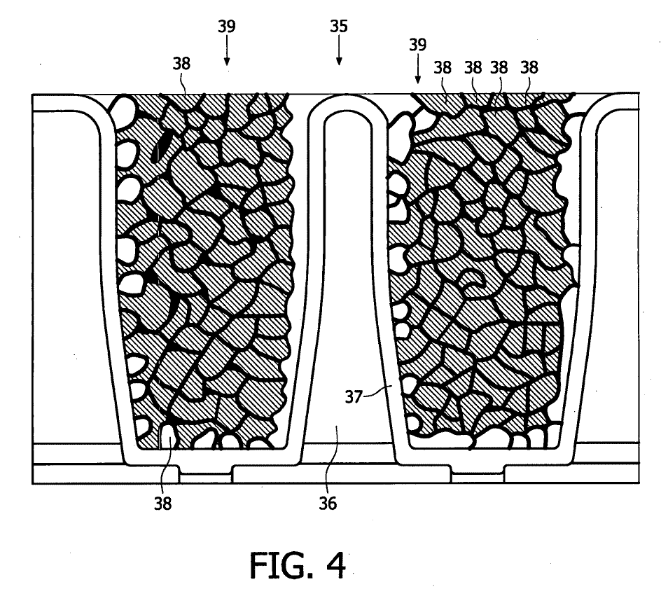

FIG. 4 shows a detailed view of an electrode of an electrochemical energy source according to the invention,

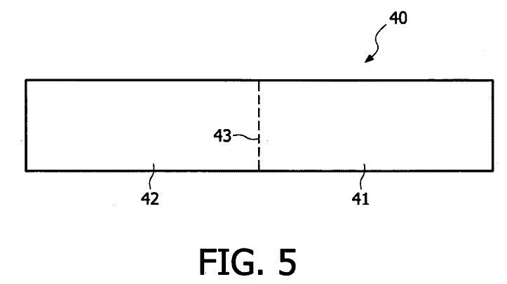

FIG. 5 shows a schematic view of a monolithic system in package according to

the invention,

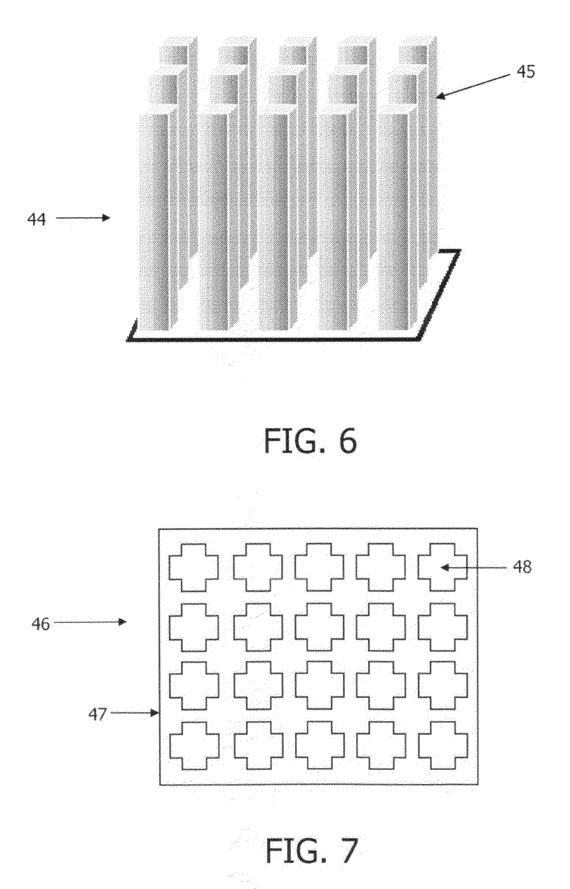

FIG. 6 shows a schematic perspective view of a first electrode to be used within an electrochemical source according to the invention, and

FIG. 7 shows a schematic top view of another first electrode to be used within an electrochemical source according to the invention.

FIG. 1 shows a perspective view of an electrochemical energy source 1 according to the invention, more particularly a Li-ion micro battery according to the invention. The energy source 1 comprises a crystalline silicon substrate 2 which functions as a part of a negative electrode of the energy source 1. The silicon substrate 2 may for example be formed by a silicon wafer often used for ICs. The substrate 2 may have a thickness larger than 20 micrometer, larger than 100 micrometer or even larger than 500 micrometer. In an upper surface 3 of the silicon substrate 2 several slits 4 are etched by way of existing etching techniques. The dimensioning of these slits 4 can be arbitrary. Preferably, the width of a slit 4 is approximately between 2 and 10 micrometer and the depth of the slit 4 is approximately between 10 and 100 micrometer. In the slits 4 a doped amorphous silicon top layer 5 is deposited onto the substrate 2. In the shown embodiment the layer 5 is subjected to a surface treatment, as a result of which the top layer 5 is provided with multiple surface increasing grains, which is shown by means of an undulated line. Both the substrate 2 and the top layer 5 form the first electrode of the energy source 1. On top of the top layer 5 a solid-state electrolyte layer 6 is deposited. The electrolyte layer 5 has a thickness of about 1 micrometer, and is preferably made of Lithium Phosphorus Oxynitride (LiPON). On the LiPON layer 5 a positive electrode layer 7 is deposited with a thickness of about 1 micrometer. The positive electrode 7 is preferably made of LiCoO₂, eventually mixed with carbon fibers. The depositing of the electrolyte 6 and the positive electrode 7 onto the upper surface 3 of the substrate 2 occurs by way of conventional depositing techniques, such as chemical or physical vapor deposition, and atomic layer deposition. Since the substrate 2 is provided with multiple slits 4 on one side and the top layer 5 of the first electrode is provided with multiple surface increasing grains on the other side, the contact surface between both electrodes 2, 5, 7 and the electrolyte 6 has been increased (significantly) per volume unit, resulting in an improved (maximized) rate capability and power density and energy density in the energy source 1. An aluminum current collector 8 is coupled to the positive electrode 6, while the substrate 2 is coupled to another current collector 9. The construction of the energy source 1 as shown is a relatively efficient and simple construction, and is furthermore relatively simple to manufacture. Moreover, the performance of the shown energy source 1 is optimized by minimizing the layer thickness of the electrolyte and maximizing the mutual contact surface between the components 2, 5, 6, 7 of the energy source 1 due to the resultant of the slits 4 provided in the substrate 2 on one side and the (nano)grains applied formed in or on the top layer 5 on the other side.

FIG. 2 shows a cross section of another electrochemical energy source 10 according to the invention. The energy source 10 comprises a substrate 11, which functions as the negative electrode of the energy source 10. Both an upper surface 12 and a lower surface 13 of the substrate 11 are provided with cavities 14, 15 by means of conventional etching techniques. Moreover, the substrate is bilaterally provided with a top layer 16, 17, wherein each top layer 16, 17 is made of amorphous silicon and is provided with more or less hemispherical silicon grains 18, 19. The grains 18, 19 are shown schematically in this Figure. The grains 18, 19 are provided at the upper surface 12 respectively lower surface 13 of the substrate 11, and are thus not merely provided within the cavities 14, 15. Both on the upper surface 12 and on the lower surface 13 an electrolytic layer 20, 21 is deposited. Application of the grains 18, 19 leads to a significant increase (approximately 2 to 2.5 times) of the effective contact surface between the top layers 16, 17 and the according electrolytic layers 20, 21, and hence a substantially equal increase of power density and energy density of the energy source 10. On top of each electrolytic layer 20, 21 subsequently a positive electrode 22, 23 is deposited. The positive electrodes 22, 23 are each (at least) partially covered by a current collector 24, 25. Both current collectors 24, 25 are mutually coupled (not shown). The substrate 11 is also provided with a separate current collector 26. The intercalation mechanism and materials used in this energy source 10 can be various. The energy source 10 as shown can for example form a Li-ion (micro)battery. As already aforementioned the surfaces 12, 13 of the substrate 11 are patterned for improving the energy density and power density of the energy source 7. These densities are further improved by a factor 2 to 2.5 times by means of the grains 18, 19. As the substrate 11, which can be used at the same time as e.g. chip carrier, and the top layers 16, 17 function as storage of ions, a relatively effective construction is an energy source 10 can be obtained. In practice, a surface of the positive electrodes 22, 23 opposite to the substrate 11 will have to be leveled and/or smoothed by means of a conductive leveling layer. However, for simplicity reasons this leveling layer is not shown in this Figure. It is noted that FIGS. 1 and 2 are not drawn to scale. For this reason, the relative thickness of the different layers used in the energy sources 1, 7 can thus vary.

FIG. 3 shows an exaggerated detailed view of yet another electrochemical energy source 27, in particular a Li-ion (micro)battery, according to the invention. In this FIG. 3, it is shown that the energy source 27 comprises a conductive substrate 28 made of crystalline silicon on top of which a barrier layer 29 for ions is deposited. On the barrier layer 29 a top layer 30 is applied, wherein the top layer 30 is made of amorphous (α-)silicon. The top layer 30 is provided with multiple grains 31, wherein each grain 31 is formed by a nucleus of atomic silicon 32. The grains 31 can either be applied directly to the barrier layer 29, or can be supported at least partially by the top layer 30. Application of the grains 31 results in a significant increase of effective surface area of the top layer 30. In the energy source 27 as shown the substrate 28, the barrier layer 29 and the top layer 30 (including the grains 31) together form a first (negative) electrode 32 of the energy source 27. On top of this first electrode 27, in particular on top of the top layer 30, an electrolytic layer 33, such as LiPON, is provided. An upper surface of said electrolytic layer 33, opposite to the top layer 30, has accordingly also a patterned (undulated) geometry, whereupon a second electrode 34, in particular made of LiCoO2, is deposited. In practice, the second electrode 34 is leveled by means of aluminum layer of about 2 millimeter, which is deposited onto said electrode 34 by means of conventional sputtering techniques. Due to the rippled upper surface of the electrolytic layer 33, the contact surface area between the electrolytic layer 33 and the second electrode 34 is increased significantly, which may result in a significant increase of power density and energy density when compared to the power density and energy density of conventional batteries. It is noted that the top layer 30 is adapted for (temporarily) storage and release of lithium ions and thus functions as an intercalation layer. Diffusion of lithium ions through the substrate 28 can be prevented by the barrier layer 29, the latter being only permeable for electrons.

FIG. 4 shows a detailed view of an electrode 35 of an electrochemical energy source according to the invention. The electrode 35 is in particularly suitable to be applied as electrode in a Li-ion battery. The electrode 35 comprises a silicon substrate 36, and a top layer 37 made of doped amorphous silicon deposited onto said substrate 36. During a in situ process more or less hemispherical grained silicon (HSG) 38 can be deposited onto said top layer 37, thereby resulting in at least a doubling of the effective contact surface area, which can increase the power density and the energy density of the energy source correspondingly. In the embodiment as shown the grained silicon 38 is applied in a cavity 39 of the substrate 36. Application of cavities 39 in the substrate leads to a further increase of the effective surface area, and hence to a further increase of the power density and energy density of the energy source. However, it is also conceivable to apply the grained silicon outside these cavities 39 or even without these cavities 39.

FIG. 5 shows a schematic view of a monolithic system in package (SiP) 40 according to the invention. The SiP 40 comprises an electronic module or device 41 and an electrochemical energy source 42 according to the invention coupled thereto. The electronic module or device 41 and the energy source 42 are separated by a barrier layer 43. Both the electronic module or device 41 and the energy source 42 are mounted and/or based on the same monolithic substrate (not shown). The construction of the energy source 42 can be arbitrary, provided that the substrate is used as (temporary) storage medium for ions and in this way thus functions as an electrode, and that this same electrode is provided with multiple surface increasing particles, in particular hemispherical grained silicon (HSG). The electronic module or device 41 can for example be formed by a display, a chip, a control unit, et cetera. In this way numerous autonomous (ready-to-use) devices can be realized in a relatively simple manner.

FIG. 6 shows a schematic perspective view of a first electrode 44 to be used within an electrochemical source according to the invention. The electrode 44 comprises multiple bar-like pillars 45, which are oriented substantially vertically (in the orientation shown), and which are positioned substantially equidistantly. The pillars 45 of the first electrode 44 are preferably formed by an etching process. The pillars 45 are preferably at least partially covered by a solid-state electrolyte (not shown) to increase the effective contact area between the first electrode 44 and the electrolyte. In this manner an electrochemical energy source can be realized which is substantially equivalent, though inverted, to the electrochemical energy sources 1, 10, 27 according to FIGS. 1-3.

FIG. 7 shows a schematic top view of another first electrode 46 to be used within an electrochemical source according to the invention. The first electrode 46 comprises a substrate 47 that is provided with multiple pillar-shaped protruding elements 48. The protruding elements 48 each have a substantially cruciform cross-section to (further) increase to the external surface and mechanical strength of each protruding element 48 in a predefined and controlled manner with respect to the external surface of the pillars 45 shown in FIG. 6. During manufacturing of the electrochemical source the protruding elements 48 (and the substrate 47) of the first electrode 46 are covered by a solid-state electrolyte (not shown) on top of which a second electrode (not shown) is deposited. In this manner an advantageous inverted structure of the electrochemical energy source can be realized with respect to the electrochemical sources 1, 10, 27 according to FIGS. 1-3.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source (1, 7, 22) comprising at least one assembly of:
a first electrode (2, 8),
a second electrode (6, 15, 16), and
an intermediate solid-state electrolyte (5, 13, 14) separating said first electrode (2, 8) and said second electrode (6, 15, 16),
characterized in that said first electrode (2, 8) comprises a conductive substrate (2, 8) and a conductive top layer applied on said substrate, wherein said top layer is at least partially provided with multiple surface increasing grains, on which top layer the solid-state electrolyte (5, 13, 14) and the second electrode (6, 15, 16) being deposited.

2. Electrochemical energy source (1, 7, 22) according to claim 1, characterized in that the first electrode is provided with a plurality of cavities (4, 11, 12) of an arbitrary shape, said electrolyte (5, 13, 14) and said second electrode (6, 15, 16) at least being applied to at least a part of an inner surface of said cavities (4, 11, 12).

3. Electrochemical energy source (1,7, 22) according to claim 2, characterized in that at least a part of the cavities (4, 11, 12) forms slits (4), pillars or holes.

4. Electrochemical energy source (1, 7, 22) according to claim 2, characterized in that the inner surface of the cavities of the first electrode is at least substantially covered by the surface increasing grains.

5. Electrochemical energy source (1, 7, 22) according to claim 1, characterized in that the first electrode (2, 8) is provided with at least one protruding element, said electrolyte (5, 13, 14) and said second electrode (6, 15, 16) at least being deposited onto at least a part of said protruding element.

6. Electrochemical energy source (1, 7, 22) according to claim 5, characterized in that the at least one protruding element is formed by a pillar.

7. Electrochemical energy source (1, 7, 22) according to claim 6, characterized in that the first electrode (2, 8) is provided with multiple pillars, said electrolyte (5, 13, 14) and said second electrode (6, 15, 16) at least being deposited onto at least a part of said pillars.

8. Electrochemical energy source (1, 7, 22) according to claim 1, characterized in that the diameter of the surface increasing grains is substantially lain between 10 and 200 nanometer, preferably between 10 and 60 nanometer.

9. Electrochemical energy source (1, 7, 22) according to claim 1, characterized in that the first electrode (2, 8) is at least partially adapted for storage of ions of at least one of following atoms: H, Li, Be, Mg, Na and K.

10. Electrochemical energy source (1, 7, 22) according to claim 1, characterized in that the substrate (2, 8) is made of at least one of the following materials: C, Sn, Ge, Pb, Al, and, preferably doped, Si.

11. Electrochemical energy source (1, 7, 22) according to claim 1, characterized in that the top layer is substantially made of amorphous silicon.

12. Electrochemical energy source (1, 7, 22) according to claim 1, characterized in that the solid-state electrolyte (5, 13, 14) and the second electrode (6, 15, 16) are deposited on multiple sides (9, 10) of the substrate (2, 8).

13. Electrochemical energy source (1, 7, 22) according to claim 1, characterized in that the substrate and the top layer are separated by means of an electron-conductive barrier layer adapted to at least substantially preclude diffusion of intercalating ions into said substrate (2, 8).

14. Electrochemical energy source (1, 7, 22) according to claim 13, characterized in that said barrier layer is at least substantially made of at least one of the following compounds: tantalum, tantalum nitride, titanium, and titanium nitride.

15. Electronic module provided with at least one electrochemical energy source according to claim 1.

16. Electronic device (21) provided with at least one electrochemical energy source (1, 7, 22) according to claim 1.

17. Electronic device (21) according to claim 16, characterized in that the electronic device is formed by an integrated circuit (IC).

18. Electronic device (21) according to claim 16, characterized in that the electronic device and the electrochemical energy source (1, 7, 22) form a System in Package (SiP) (20).

19. Method for manufacturing of an electrochemical energy source (1, 7, 22) according to claim 1, comprising the steps of:
applying a conductive top layer on a conductive substrate, wherein said top layer is provided with multiple surface increasing grains,
depositing the solid-state electrolyte (5, 13, 14) on at least a part of the top layer, and
subsequently depositing of the second electrode (6, 15, 16) on at least a part of the electrolyte.

20. Method according to claim 19, characterized in that depositing of the top layer onto the substrate according to step A) is realized by the steps:
applying a top layer of amorphous silicon onto said substrate,
patterning said top layer by making use of etching techniques, and
allowing surface increasing grains to grow selectively onto the patterned top layer.

21. Method according to claim 20, characterized in that step D) is executed at a temperature of between 515 and 525 degrees Celsius.

22. Method according to claim 20, characterized in that step E) and step F) are executed at a temperature of between 545 and 610 degrees Celsius.

23. Method according to claim 19, characterized in that the method is provided with step G) comprising patterning at least one contact surface (3, 9, 10) of the substrate (2, 8), wherein step G) is applied prior to step A).

24. Method according to claim 19, characterized in that the method is provided with step H) comprising depositing of a electron-conductive barrier layer onto the substrate, wherein step H) is applied prior to step A), and wherein during step A) the top layer is deposited onto said barrier layer.
